(19) United States
(12) Patent Application Publication
(10) Pub. No.: US 2008/0117352 A1
(43) Pub. Date: May 22, 2008

(54) Liquid crystal display device

(75) Inventor: Joo-yeon Won, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/985,299

(22) Filed: Nov. 13, 2007

(30) Foreign Application Priority Data
Nov. 21, 2006 (KR) 10-2006-0115466

(51) Int. Cl. G02F 1/1333

(52) U.S. Cl. 349/58

(57) ABSTRACT

A liquid crystal display device which includes a liquid crystal display panel, a mold which comprises a first mold and a second mold elongated in a first direction and facing each other, and supports the liquid crystal display panel. A lamp is arranged in a second direction perpendicular to the first direction, and comprises a lamp main body and an electrode provided in an end part of the lamp main body. Sockets are provided, the sockets respectively included in end parts of the first mold and the second mold. The sockets include a socket main body to accommodate the electrode and a conductive contact member to contact the electrode. A cover is provided for the lamp and the sockets.

### CROSS-REFERENCE TO RELATED APPLICATIONS

This application claims priority from Korean Patent Application No. 10-2006-0115466, filed on Nov. 21, 2006, in the Korean Intellectual Property Office, the disclosure of which is incorporated herein by reference.

### BACKGROUND OF THE INVENTION

1. Field of the Invention

Apparatuses consistent with the present invention relate to a liquid crystal display device.

2. Description of the Related Art

A liquid crystal display device includes a liquid crystal display (LCD) panel and a backlight unit. The LCD panel includes a first substrate having a thin film transistor, a second substrate facing the first substrate and a liquid crystal layer interposed between the first and second substrates. The LCD panel does not emit light itself, and thus receives light from the backlight unit. Transmittivity of light emitted by the backlight unit is adjusted by an arrangement of liquid crystals.

The backlight unit can be of a direct type backlight unit or a side type backlight unit. In the side type backlight unit, a lamp is disposed along a lateral side of a light guiding plate. The display panel employing the side type backlight unit is thin and accordingly is typically used in portable devices, including laptop computers.

An electrode of the lamp is connected with an inverter to drive the lamp. In a conventional LCD device, a wire is soldered to the electrode to be connected to the inverter. However, such a connection method requires an additional process such as soldering and causes errors during the soldering.

### SUMMARY OF THE INVENTION

Accordingly, it is an aspect of the present invention to provide a liquid crystal display device which is manufactured with a simplified process.

Additional aspects and/or advantages of the present invention will be set forth in part in the description which follows and, in part, will be obvious from the description, or may be learned by practice of the present invention.

The foregoing and/or other aspects of the present invention can be achieved by providing a liquid crystal display device, comprising: a liquid crystal display panel; a mold which comprises a first mold and a second mold elongated in a first direction and facing each other, and supports the liquid crystal display panel; a lamp which is arranged in a second direction perpendicular to the first direction, and comprises a lamp main body and an electrode provided in an end part of the lamp main body; sockets which are respectively provided in end parts of the first mold and the second mold, and comprises a socket main body to accommodate the electrode and a conductive contact member to contact the electrode; and a cover which accommodates the lamp and the sockets.

According to an aspect of the invention, the mold and the socket main body are formed as a single body.

According to an aspect of the invention, the first mold and the second mold are separated from each other.

According to an aspect of the invention, the liquid crystal display device further comprises a third mold which extends from one of the pair of sockets to the other socket.

According to an aspect of the invention, the third mold connects the pair of sockets with each other.

According to an aspect of the invention, the liquid crystal display device further comprises a wire which is connected with the conductive contact member, wherein the third mold comprises a guide groove which guides the wire.

According to an aspect of the invention, the lamp main body is provided between the third mold and the cover.

According to an aspect of the invention, the mold is connected with the socket main body.

According to an aspect of the invention, the electrode comprises a first electrode which is formed in a first end part of the lamp main body and a second electrode which is formed in a second end part of the lamp main body, and the sockets comprise: a first socket having a first socket main body provided in the end part of the first mold and accommodating the first electrode, and a first conductive contact member provided in the first socket main body and contacting the first electrode; and a second socket having a second socket main body provided in the end part of the second mold and accommodating the second electrode and a second conductive contact member provided in the second socket main body and contacting the second electrode.

According to an aspect of the invention, the cover comprises a conductive material, and at least a part of the second conductive contact member contacts the cover.

According to an aspect of the invention, the liquid crystal display device further comprises a first wire which is connected with the first conductive contact member.

According to an aspect of the invention, the liquid crystal display device further comprises a ground contact member which is adjacent to the first socket main body and contacts the cover, and a second wire which is connected with the ground contact member.

According to an aspect of the invention, the ground contact member comprises a first ground portion which is in parallel with the liquid crystal display panel and contacts the cover, and a second ground portion which is bent from the first ground portion, extends toward the liquid crystal display panel and is connected with the second wire.

According to an aspect of the invention, the lamp is moved in the first direction and accommodated in the socket main body.

According to an aspect of the invention, the liquid crystal display device further comprises a socket cover which is connected with the socket main body, and prevents the conductive contact member from being exposed to the outside.

According to an aspect of the invention, the liquid crystal display device further comprises a light guiding plate which is provided behind the liquid crystal display panel and between the first mold and the second mold.

The foregoing and/or other aspects of the present invention can be achieved by providing a liquid crystal display device, comprising: a liquid crystal display panel; a light guiding plate which is provided behind the liquid crystal display panel; a mold, comprising a part which is disposed between the light guiding plate and the liquid crystal display panel and supports the liquid crystal display panel; a lamp which is arranged along an incident side of the light guiding plate, and comprises a lamp main body and an electrode provided in an end part of the lamp main body; and a socket comprising a socket main body which is integrally formed with the mold, and accommodate the electrode and a conductive contact member to contact the electrode.

The foregoing and/or other aspects of the present invention can be achieved by providing a liquid crystal display device, comprising: a liquid crystal display panel; a light guiding plate which is provided behind the liquid crystal display panel; a mold, comprising a part which is disposed between the light guiding plate and the liquid crystal display panel, and supports the liquid crystal display panel; a lamp which is arranged along an incident side of the light guiding plate, and comprises a lamp main body and an electrode provided in an end part of the lamp main body; and a socket which is connected with the mold, and comprises a socket main body to accommodate the electrode and a conductive contact member to contact the electrode.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is an exploded perspective view of a liquid crystal display device according to a first exemplary embodiment of the present invention;

FIG. 2 is an enlarged view of region A in FIG. 1;

FIG. 3 illustrates main parts which are coupled with each other in the liquid crystal display device according to the first exemplary embodiment of the present invention;

FIG. 4 is an enlarged perspective view of structures showing electrical connections to a lamp of the liquid crystal display device according to the first exemplary embodiment of the present invention;

FIG. 5 is a sectional view, taken along line V-V in FIG. 3;

FIGS. 6 to 8 are exploded perspective views of main parts of a liquid crystal display device according to second to fourth exemplary embodiments of the present invention;

FIG. 9 is a perspective view illustrating main parts which are coupled to each other in the liquid crystal display device according to the fourth exemplary embodiment of the present invention;

FIG. 10 is an exploded perspective view of a first socket of the liquid crystal display device according to the fourth exemplary embodiment of the present invention;

FIG. 11 is an exploded perspective view of a second socket of the liquid crystal display device according to the fourth exemplary embodiment of the present invention;

FIG. 12 illustrates power supply to a lamp of the liquid crystal display device according to the fourth exemplary embodiment of the present invention; and

FIG. 13 is an exploded perspective view of main parts of a liquid crystal display device according to a fifth exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions are avoided.

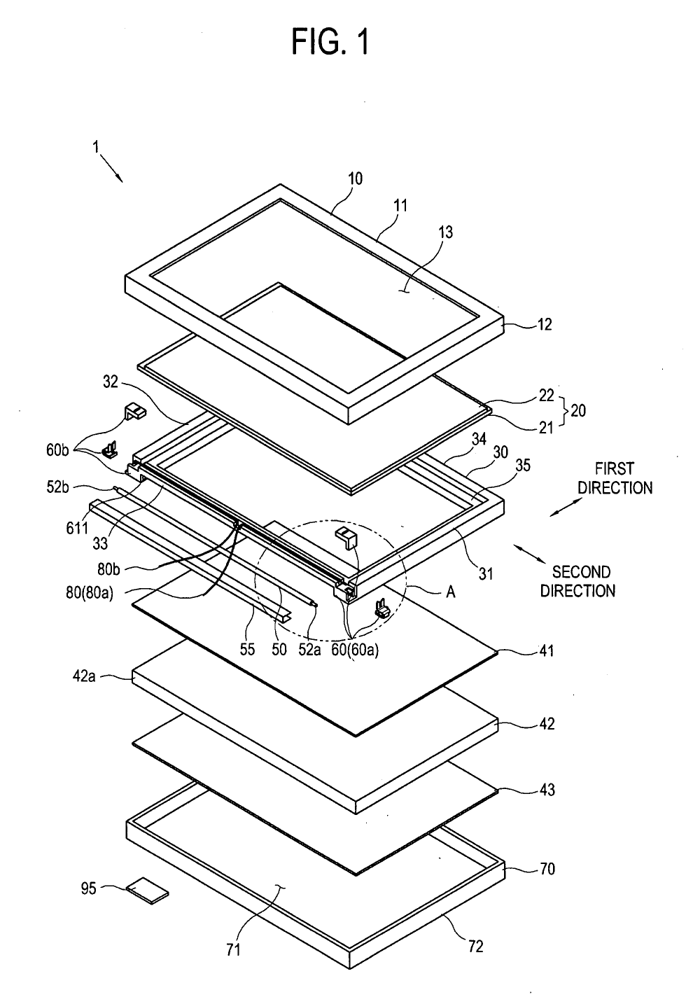

A liquid crystal display device according to a first exemplary embodiment of the present invention will be described with reference to FIGS. 1 to 5.

As shown in FIG. 1, a liquid crystal display device 1 includes a liquid crystal display panel 20, an optical film 41 which is disposed behind the liquid crystal display panel 20, a light guiding plate 42 which is provided behind the optical film 41, a lamp 50 which is provided along an incident side 42a of the light guiding plate 42, a lamp cover 55 which covers the lamp 50 and a reflection plate 43 which is provided behind the light guiding plate 42.

The foregoing elements are accommodated between an upper cover 10 and a lower cover 70. The liquid crystal display panel 20 is supported by a mold 30. The liquid crystal display device 1 further includes a socket 60 and a wire 80 to supply power to the lamp 50. The wire 80 is connected with an inverter 95 which is provided at a rear surface of the lower cover 70.

The upper cover 10 includes a first cover portion 11 which is shaped like a rectangular band and a second cover portion 12 which is bent from the first cover portion 11 and extends downwards. An opening 13 of the first cover portion 11 exposes a display region of the liquid crystal display panel 20 therethrough. The upper cover 10 may include aluminum or stainless steel.

The liquid crystal display panel 20 includes a first substrate 21 which has a thin film transistor, and a second substrate 22 which faces the first substrate 21. The second substrate 22 may include a color filter. A liquid crystal layer (not shown) is provided between the first and second substrates 21 and 22. The first substrate 21 is larger than the second substrate 22. A driving circuit (not shown) is attached to the first substrate 21 which does not face the second substrate 22.

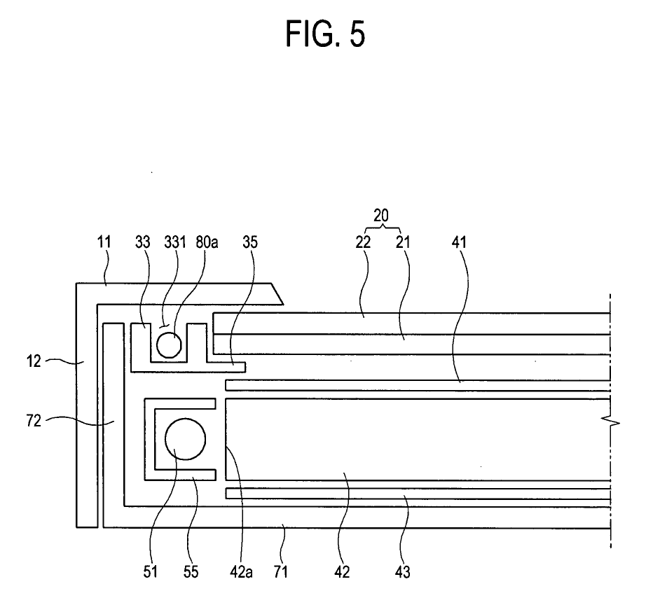

The mold 30 is shaped like a rectangular band and includes plastic. The mold 30 includes a first mold 31 and a second mold 32 which extend in a first direction and face each other, a third mold 33 and a fourth mold 34 which extend in a second direction, a transverse direction of the first direction, and face each other, and a fifth mold 35 which supports the liquid crystal display panel 20. As shown in FIG. 5, the fifth mold 35 extends between the light guiding plate 42 and the liquid crystal display panel 20.

The third mold 33 is thinner than the first and second molds 31 and 32 so that the lamp 50 and the lamp cover 55 are provided below the third mold 33.

The optical film 41 which is disposed behind the liquid crystal display panel 20 is shaped like a rectangle. The optical film 41 may include one of a diffusion film, a prism film, a reflective polarizing film and a protection film. The optical film 41 may be plurally provided.

The light guiding plate 42 includes acrylic resin such as poly methylstyrene (copolymer of methylmethacrylate and styrene) or polymethyl methacrylate (PMMA). The light guiding plate 42 guides light from the lamp to the optical film 41 uniformly.

The lamp 50 may include a cold cathode fluorescent lamp (CCFL) or an external electrode fluorescent lamp (EEFL).

AS shown in FIG. 5, the lamp 50 is disposed along the incident side 42a of the light guiding plate 42. The lamp 50 includes a lamp main body 51 and electrodes 52 which are provided in opposite end part of the lamp main body 51.

The lamp 50 is covered by the lamp cover 55 which reflects light from the lamp 50 to the light guiding plate 42. The lamp cover 55 may include a double layer. An internal surface of the lamp cover 55 may include a polyethyleneterephthalate (PET) layer while an external surface thereof may include an aluminum layer having high thermal conductivity.

Returning to FIG. 1, the reflection plate 43 is provided behind the light guiding plate 42, and reflects incident light to the light guiding plate 42. The reflection plate 43 includes plastic such as polyethyleneterephthalate (PET) or poly carbonate (PC).

The socket 60 supports the lamp 50, and drives the lamp 50 by being connected with the electrodes 52. The socket 60 includes a first sock 60a which is provided in an end part of the first mold 31, and a second socket 60b which is disposed in an end part of the second mold 32. The first socket 60a and the second socket 60b have the same configuration. Hereinafter, the focus will be given to the first socket 60a to be described.

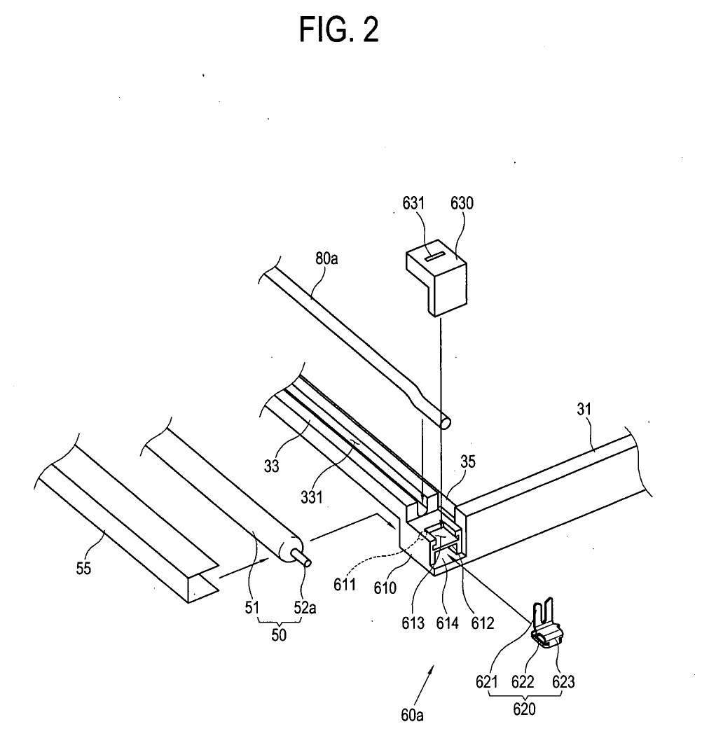

As shown in FIG. 2, the first socket 60a includes a socket main body 610, a conductive contact member 620 and a socket cover 630.

The socket main body 610 is integrally formed with the mold 31, and provided where the first mold 31 and the third mold 33 are connected. An insertion hole 611 is formed in the socket main body 610, into which the electrodes 52a and 52b of the lamp 50 are inserted. The insertion holes 611 which are respectively provided in the first socket 60a and the second socket 60b face each other in the second direction. The socket main body 610 includes an adherence part 612 which is shaped like a plate, to which conductive contact member 620 is secured. A first accommodating space 613 is provided above the adherence part 612 and a second accommodating space 614 is provided under the adherence part 612.

The conductive contact member 620 includes metal, such as stainless steel, or copper. The conductive contact member 620 includes a wire connector 621 which is connected with the wire 80, an electrode connector 622 which is connected with the electrodes 52 and a deformer 623 which connects the wire connector 621 and the electrode connector 622.

When the conductive contact member 620 is inserted into the adherence part 612, the deformer 623 is deformed so that the wire connector 621 is spaced from the electrode connector 622. Then, an elastic force of the deformer 623 makes the conductive contact member 620 securely connected to the adherence part 612.

While being adhered to the connected part 612, the wire connector 621 is accommodated in the first accommodating space 613 and the electrode connector 622 is accommodated in the second accommodating space 614.

The socket cover 630 is connected to the socket main body 610, and prevents the conductive contact member 620 from being exposed to the outside. The socket cover 630 may be slidably connected with the socket main body 610. A projection and a groove (not shown) are formed in the socket cover 630 and the socket main body 610 to connect them.

An accommodation hole 631 is provided in the socket cover 630 to accommodate the wire connector 621 extending to the outside of the first accommodating space 613.

Returning to FIG. 1, the lower cover 70 includes a third cover portion 71 which is shaped like a rectangle, and a fourth cover portion 72 which is bent from the third cover portion (or base) 71 and extends upwards. The lower cover 70 may include a conductive material such as aluminum or stainless steel.

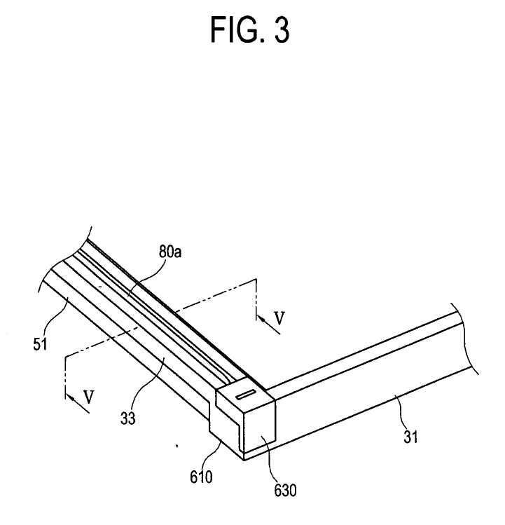

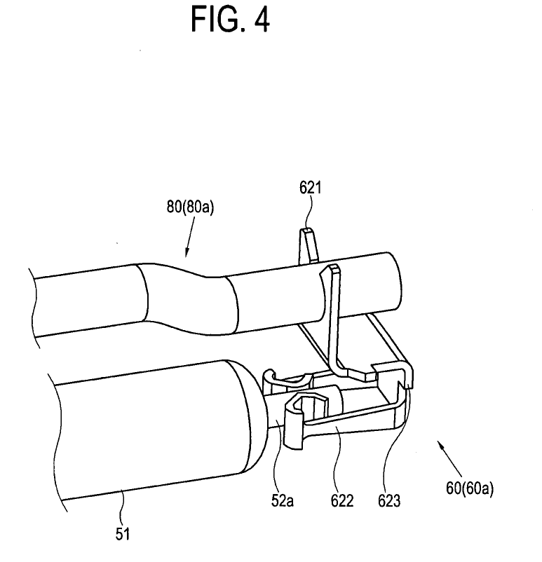

A connection process of the lamp 50 and the socket 60, and the wire 80 and the socket 60 is described below with reference to FIGS. 3 and 4.

The lamp 50 is inserted into the insertion holes 611 of the socket main body 610 in the second direction. As the lamp 50 is inserted thereinto, the electrodes 52a and 52b are connected with the electrode connector 622. The electrode connector 622 is deformed by the insertion of the electrodes 52a and 52b. With the elastic force of the deformed electrode connector 622, the electrodes 52a and 52b and the electrode connector 622 are connected with each other more stably.

The wire 80 is inserted into the wire connector 621 in a vertical direction of the liquid crystal display panel 20. While being inserted thereto, a coating layer of the wire 80 is removed, and the wire 80 is electrically connected with the wire connector 621. The wire 80 is accommodated in a wire guide 331 formed in an upper surface of the third mold 33, thereby preventing the liquid crystal display device 1 from becoming thicker by the wire 80 (refer to FIG. 5).

When the lamp 50 and the wire 80 are connected with the conductive contact member 620, the socket cover 630 is connected with the socket main body 610 to cover the conductive contact member 620. FIG. 3 illustrates the socket cover 630 and the socket main body 610 which are connected with each other.

In another exemplary embodiment of the present invention, the lamp 50 may be connected with the socket 60 after the socket cover 630 is connected with the socket main body 610.

According to the first exemplary embodiment of the present invention, the wire 80 is not soldered to electrodes 52 to supply power to the lamp 50, thereby simplifying the manufacturing process. Also, the socket 60 is integrally formed with the mold 30 and does not require an addition space. Thus, the thickness and width of the liquid crystal display device 1 do not increase.

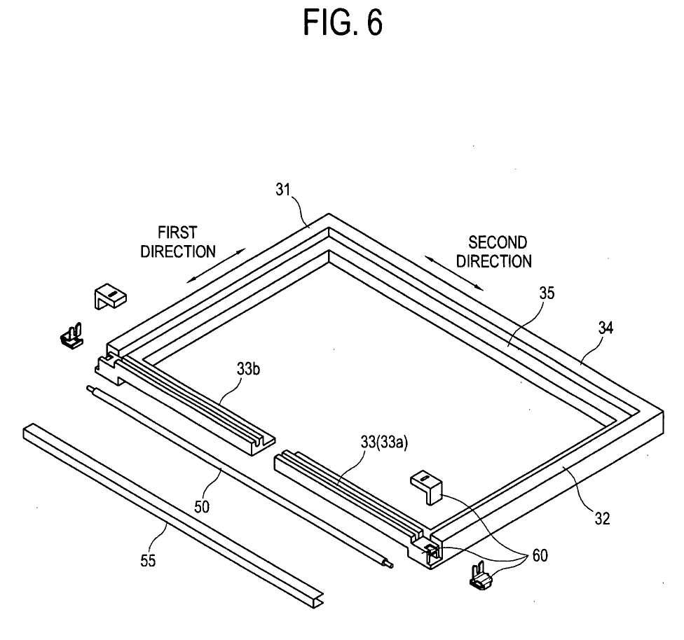

A liquid crystal display device 1 according to a second exemplary embodiment of the present invention is described below with reference to FIG. 6.

A third mold 33 is divided into two parts, a first sub mold 33a and a second sub mold 33b. A mold 30 is deformed so that the first sub mold 33a and the second sub mold 33b are spaced from each other in a second direction, thereby inserting a lamp 50 into a socket 60 more easily.

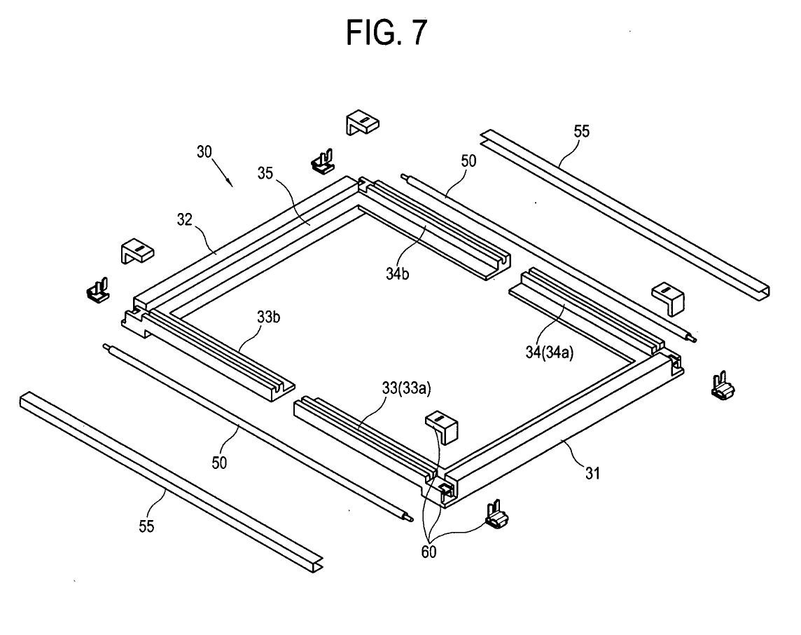

A liquid crystal display device according to a third exemplary embodiment of the present invention is described below with reference to FIG. 7.

A third mold 33 is divided into two parts, a first sub mold 33a and a second sub mold 33b. A fourth mold 34 is also divided into two parts, a third sub mold 34a and a fourth sub mold 34b. The fourth mold 34 is similar to the third mold 33 and thinner than a first mold 31 and a second mold 32.

Sockets 60 are provided at four corners of a light guiding plate 42. There are provided a pair of lamps 50. According to the fourth exemplary embodiment of the present invention, the lamps 50 are provided in opposite sides of the light guiding plate 42, thereby improving brightness and inserting the lamps 50 into the socket 60 more easily.

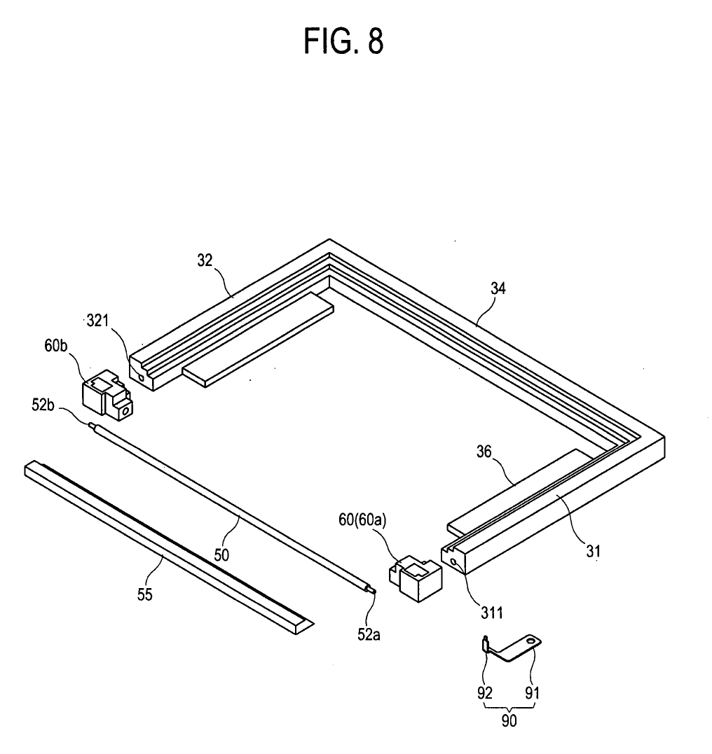

A liquid crystal display device according to a fourth exemplary embodiment of the present invention is described below with reference to FIGS. 8 to 12.

A mold 30 has a [symbol] -shape, and is removed where a lamp 50 is disposed. The mold 30 includes a sixth mold 36 which extends inwards. A reflection plate 43 and a light guiding plate 42 are sequentially provided on the sixth mold 36.

A socket 60 is independently provided, and is connected with the mold 30. The socket 60 includes a first socket 60a which is provided in an end part of a first mold 31, and a second socket 60b which is provided in an end part of a second mold 32.

A first electrode 52a which is connected with the first socket 60a receives power while a second electrode 52b which is connected with the second socket 60b is connected to the ground.

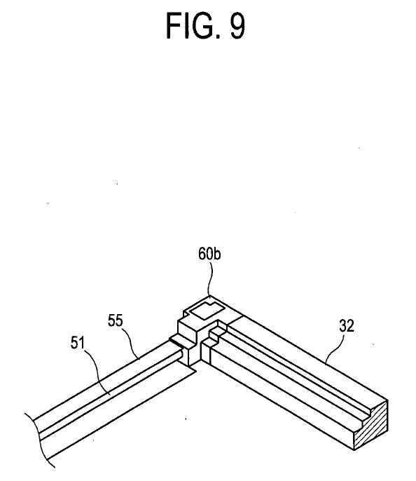

The lamp 50 is connected with the socket 60 similarly to those in the first exemplary embodiment of the present invention, and the description thereof will not be repeated. FIG. 9 illustrates the mold 32 and the second socket 60b connected with each other, and the second socket 60b connected with the lamp 50.

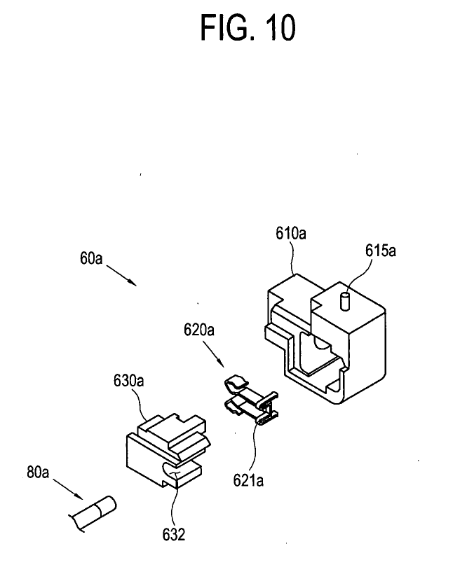

First socket 60a is described below with reference to FIG. 10.

The first socket 60a includes a socket main body 610a, a conductive contact member 620a and a socket cover 630a.

A coupling projection 615a is formed in the socket main body 610a that faces the first mold 31. The coupling projection 615a is inserted into a coupling groove 311 provided in the first mold 31 to connect the socket main body 610a and the first mold 31.

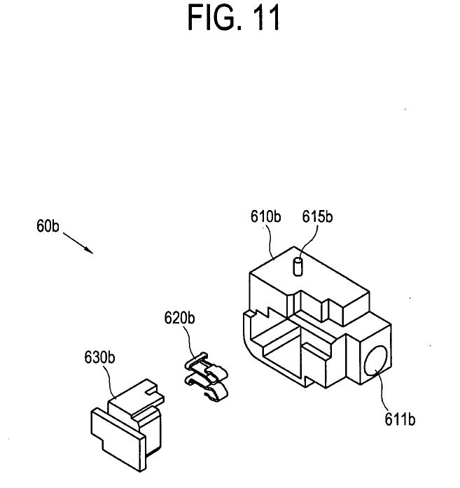

A first wire 80a (shown in FIG. 10) is connected with a wire connecter 621a provided at the conductive contact member 620a through a wire through hole 632 which is provided in a lateral side of the socket cover 630a. Hereinafter, the second socket 60b is described with reference to FIG. 11.

The second socket 60b includes a socket main body 610b, a conductive contact member 620b and a socket cover 630b.

A coupling projection 615b is formed in the socket main body 610b that faces the second mold 32. The coupling projection 615b is inserted into a coupling groove 321 provided in the second mold 32 to connect the socket main body 610b and the second mold 32.

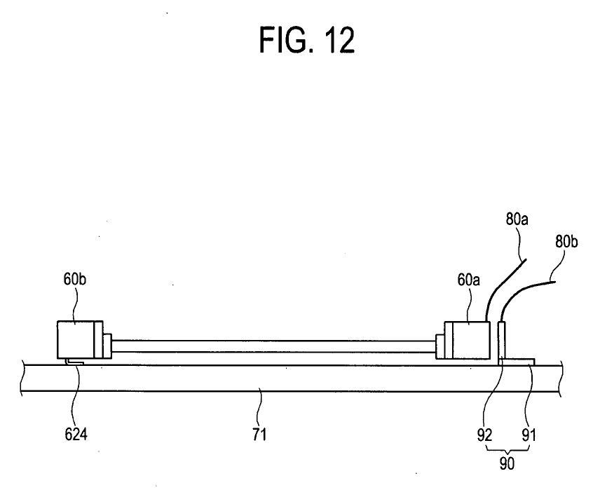

A through hole (not shown) is provided in the socket main body 610b that faces a third part 71 of a lower cover 70. A ground projection 624 (refer to FIG. 12) is provided in the conductive contact member 620b, and protrudes toward the third cover portion 71 of the lower cover 70. The ground projection 624 is exposed to the outside through the through hole.

A ground contact member 90 is disposed adjacent to the first socket 60a. The ground contact member 90 has an L shape. The ground contact member 90 includes a first ground portion 91 which is in parallel with the third cover portion 71 of the lower cover 70, and a second ground portion 92 which is bent from the first ground portion 91 and extends toward the liquid crystal display panel 20. The ground contact member 90 includes a conductive metal material.

A method of driving the lamp 50 according to the fourth exemplary embodiment of the present invention is described with reference to FIG. 12.

The first electrode 52a connected with the first socket 60a is electrically connected with the conductive contact member 620a. The first electrode 52a receives power through the first wire 80a connected with the conductive contact member 620a.

The second electrode 52b connected with the second socket 60b is electrically connected with the conductive contact member 620b. The ground projection 624 of the conductive contact member 620b is exposed to the outside and contacts the third cover portion 71 of the lower cover 70. The ground contact member 90 is disposed adjacent to the first socket 610a. The first ground portion 91 of the ground contact member 90 is connected with the third cover 71 of the lower cover 70 while the second ground portion 92 is connected with the second wire 80b. As the lower cover 70 and the ground contact member 90 include a conductive material, the second electrode 52b is electrically connected with the second wire 80b.

The first ground portion 91 of the ground contact member 90 may be fixed to the third cover portion 71 of the lower cover 70 by a screw (not shown).

The first wire 80a and the second wire 80b are adjacent to the first socket 60a, thereby connecting the wire 80 and the inverter 95 more easily.

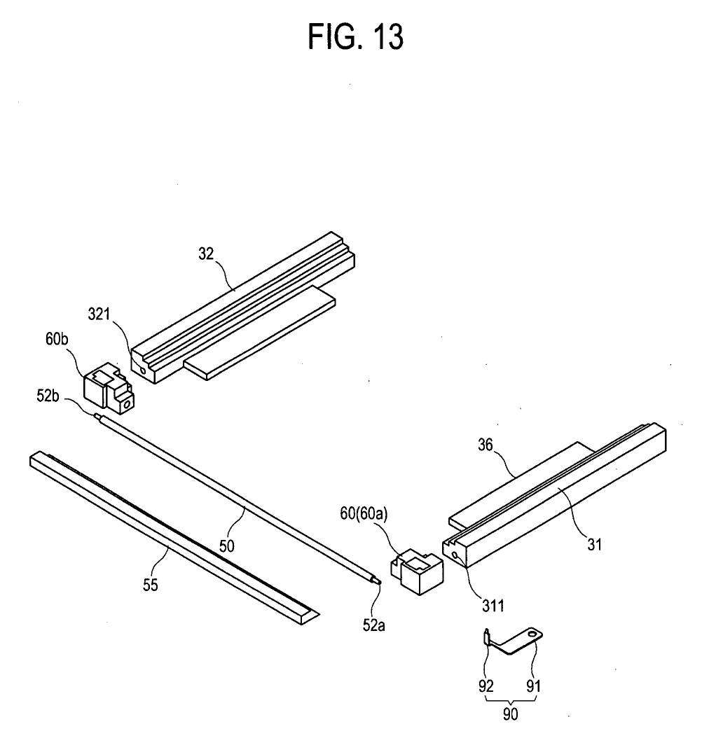

A liquid crystal display device according to a fifth exemplary embodiment of the present invention will be described with reference to FIG. 13.

A socket 60 is independently provided as the fourth exemplary embodiment of the present invention. The socket 60 is connected with a mold 30. The mold 30 includes a first mold 31 and a second mold 32 which face each other. The first mold 31 and the second mold 32 are separated from each other.

As described above, the present invention provides a liquid crystal display device which is manufactured with a simplified process.

Although a few embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A liquid crystal display device, comprising:
a liquid crystal display panel;
a mold which comprises a first mold portion and a second mold portion, elongated in a first direction and facing each other, the first and second mold portions supporting the liquid crystal display panel;
a lamp arranged in a second direction perpendicular to the first direction, the lamp comprising a lamp main body and an electrode provided in an end part of the lamp main body;
sockets which are respectively provided in end parts of the first mold and the second mold, wherein the sockets comprise a socket main body to accommodate the electrode and a conductive contact member to contact to the electrode; and
a cover associated with each lamp and the sockets.

2. The liquid crystal display device according to claim 1, wherein the mold and the socket main body are formed as a single body.

3. The liquid crystal display device according to claim 2, wherein the first mold and the second mold are separate pieces.

4. The liquid crystal display device according to claim 1, further comprising a third mold which extends from one of the pair of sockets to the other socket.

5. The liquid crystal display device according to claim 4, wherein the third mold connects the pair of sockets with each other.

6. The liquid crystal display device according to claim 4, further comprising a wire which is connected with the conductive contact member, wherein
the third mold comprises a guide groove which guides the wire.

7. The liquid crystal display device according to claim 6, wherein the lamp main body is provided between the third mold and the cover.

8. The liquid crystal display device according to claim 1, wherein the mold is connected with the socket main body.

9. The liquid crystal display device according to claim 1, wherein the electrode comprises a first electrode which is formed in a first end part of the lamp main body and a second electrode which is formed in a second end part of the lamp main body,
and the sockets comprise:
a first socket having a first socket main body provided in the end part of the first mold and accommodating the first electrode, and a first conductive contact member provided in the first socket main body and contacting the first electrode;
and a second socket having a second socket main body provided in the end part of the second mold and accommodating the second electrode and a second conductive contact member provided in the second socket main body and contacting the second electrode.

10. The liquid crystal display device according to claim 9, wherein the cover comprises a conductive material, and at least a part of the second conductive contact member contacts the cover.

11. The liquid crystal display device according to claim 10, further comprising a first wire connected with the first conductive contact member.

12. The liquid crystal display device according to claim 11, further comprising a ground contact member which is adjacent to the first socket main body and contacts the cover, and a second wire which is connected with the ground contact member.

13. The liquid crystal display device according to claim 12, wherein the ground contact member comprises a first ground portion which is in parallel with the liquid crystal display panel and contacts the cover, and a second ground portion which is bent from the first ground portion, extends toward the liquid crystal display panel and is connected with the second wire.

14. The liquid crystal display device according to claim 1, wherein the lamp is moved in the first direction and accommodated in the socket main body.

15. The liquid crystal display device according to claim 1, further comprising a socket cover which is connected with the socket main body, and prevents the conductive contact member from being exposed to the outside.

16. The liquid crystal display device according to claim 1, further comprising a light guiding plate which is provided behind the liquid crystal display panel and between the first mold and the second mold.

17. A liquid crystal display device, comprising:
a liquid crystal display panel;
a light guiding plate which is provided behind the liquid crystal display panel;
a mold, comprising a part which is disposed between the light guiding plate and the liquid crystal display panel and supports the liquid crystal display panel;
a lamp which is arranged along an incident side of the light guiding plate, and comprises a lamp main body and an electrode provided in an end part of the lamp main body; and
a socket comprising a socket main body which is integrally formed with the mold, and accommodate the electrode and a conductive contact member to contact the electrode.

18. A liquid crystal display device, comprising:
a liquid crystal display panel;
a light guiding plate which is provided behind the liquid crystal display panel;
a mold, comprising a part which is disposed between the light guiding plate and the liquid crystal display panel, and supports the liquid crystal display panel;
a lamp which is arranged along an incident side of the light guiding plate, and comprises a lamp main body and an electrode provided in an end part of the lamp main body; and
a socket which is connected with the mold, and comprises a socket main body to accommodate the electrode and a conductive contact member to contact the electrode.
